(19) United States
(12) Patent Application Publication
(10) Pub. No.: US 2026/0205910 A1
(43) Pub. Date: Jul. 16, 2026

(54) HANDLING PLMN-SPECIFIC ATTEMPT COUNTERS IN A DISASTER ROAMING REGISTRATION PROCEDURE IN A WIRELESS COMMUNICATION SYSTEM

(71) Applicant: Samsung Electronics Co., Ltd., Suwon-si (KR)

(72) Inventors: Danish Ehsan HASHMI, Bangalore (IN); Lalith KUMAR, Bangalore (IN); Pratibha Kattemane SATYAGANAPATI, Bangalore (IN); Arvind RAMAMURTHY, Bangalore (IN); Jagadeesh GANDIKOTA, Bangalore (IN); Anurag MANDILWAR, Bangalore (IN)

(21) Appl. No.: 19/529,730

(22) Filed: Feb. 4, 2026

Related U.S. Application Data
(63) Continuation of application No. PCT/KR2026/000664, filed on Jan. 12, 2026.

(30) Foreign Application Priority Data
Jan. 13, 2025 (IN) 202441098934
Jan. 2, 2026 (IN) 2024 41098934

(51) Int. Cl. H04W 36/24; H04W 4/90; H04W 60/04; H04W 84/04

(52) U.S. Cl. CPC H04W 36/24; H04W 4/90; H04W 60/04; H04W 84/042

(57) ABSTRACT

A method and a system for capability reporting for handling public land mobile network (PLMN)-specific attempt counters in a disaster roaming registration procedure in a wireless communication system are provided. The method includes receiving, by a user equipment (UE), a registration accept message from a PLMN upon, based on initiation of the disaster roaming registration procedure between the UE and the PLMN. Further, the method includes determining, by the UE, whether the registration accept message is for disaster roaming services, based on the registration accept message. Further, the method includes performing, by the UE, one of resetting a PLMN-specific attempt counter for the PLMN, based on the registration accept message being determined to not be for the disaster roaming services, or resetting the PLMN-specific attempt counter of the PLMN for a PLMN determined by the UE as having a disaster condition, based on the registration accept message being determined to be for the disaster roaming services.

### CROSS-REFERENCE TO RELATED APPLICATION(S)

This application is a continuation application, claiming priority under 35 U.S.C. § 365 (c), of an International application No. PCT/KR2026/000664, filed on Jan. 12, 2026, which is based on and claims the benefit of an Indian Provisional patent application No. 202441098934, filed on Jan. 13, 2025, in the Indian Intellectual Property Office, and of an Indian Complete patent application No. 202441098934, filed on Jan. 2, 2026, in the Indian Intellectual Property Office, the disclosure of each of which is incorporated by reference herein in its entirety.

### FIELD OF INVENTION

The disclosure relates to the field of wireless communication. More particularly, the disclosure relates to a method and system for handling a Public Land Mobile Network (PLMN)-specific attempt counters in a disaster roaming registration procedure in a wireless communication system.

### BACKGROUND

In recent years, the need for robust communication user equipments (UEs) has become increasingly critical, in the context of natural disasters and other emergencies. Wireless communication UEs, such as those governed by the 3rd Generation Partnership Project (3GPP), have been instrumental in ensuring connectivity during such events. One of the key features developed to enhance service reliability in disaster scenarios is the Minimization of Service Interruption (MINT). MINT aims to facilitate seamless service continuity for User Equipment (UE) by allowing it to connect to Public Land Mobile Networks (PLMNs) that offer disaster roaming services when the UE's home PLMN (HPLMN) is affected by a disaster.

Despite the intentions behind MINT, several challenges and limitations have been identified in its implementation. Firstly, the provision of disaster roaming services is often constrained to specific times and geographical areas, which may not align with the actual needs of affected users. This limitation can lead to significant service interruptions or delays in communication, particularly when users are located outside the predefined regions or when the disaster conditions evolve rapidly.

Another critical issue is the potential for network congestion caused by a sudden influx or outflux of Disaster Inbound Roamers. When a disaster strikes, a large number of UEs may simultaneously attempt to register with alternative PLMNs, leading to network overload and degraded service quality. This congestion not only affects the disaster-impacted areas but can also ripple through to other parts of the fifth generation (5G) UE and Evolved Packet UE (EPS), impacting overall network performance.

Further, the current UEs require PLMN operators to be promptly informed about the areas affected by a disaster condition. However, the mechanisms for disseminating this information and updating it in real-time are often inefficient, potentially delaying the response time for both operators and users. Similarly, informing Disaster Inbound Roamers when a disaster condition has ended is crucial, yet existing methods may not provide timely or accurate updates, leaving users in prolonged states of uncertainty.

Further, there are complexities related to accessing PLMNs that are on a UE's forbidden list during a disaster condition. While the 3GPP UE allows UEs to connect to such PLMNs if no other options are available, the process for doing so is not always straightforward and may involve intricate regulatory and technical considerations.

Furthermore, the management of charging information and registration attempts for Disaster Inbound Roamers adds another layer of complexity. UEs must maintain PLMN-specific attempt counters, which can become cumbersome to manage, particularly in rapidly changing disaster scenarios. The criteria for resetting these counters can also vary, leading to inconsistencies in service continuity.

The above information is presented as background information only to assist with an understanding of the disclosure. No determination has been made, and no assertion is made, as to whether any of the above might be applicable as prior art with regard to the disclosure.

### OBJECT OF INVENTION

Aspects of the disclosure are to address at least the above-mentioned problems and/or disadvantages and to provide at least the advantages described below. Accordingly, an aspect of the disclosure is to provide a method and system for handling public land mobile network (PLMN)-specific attempt counters in a disaster roaming registration procedure in a wireless communication system.

Another aspect of the disclosure is to provide a user equipment (UE) that shall reset the PLMN-specific attempt counters for the UE-determined PLMN with a disaster condition and shall not reset PLMN-specific attempt counters.

Another aspect of the disclosure is to provide a UE that shall reset the PLMN-specific attempt counters and shall not reset PLMN-specific attempt counters for the UE-determined PLMN with a disaster condition.

Additional aspects will be set forth in part in the description which follows and, in part, will be apparent from the description, or may be learned by practice of the presented embodiments.

### SUMMARY

In accordance with an aspect of the disclosure, a method, performed by a user equipment (UE), for handling public land mobile network (PLMN)-specific attempt counters in a disaster roaming registration procedure in a wireless communication system is provided. The method includes receiving, by the UE, a registration accept message from a PLMN, based on initiation of the disaster roaming registration procedure between the UE and the PLMN. Further, the method includes determining, by the UE, whether the registration accept message is for disaster roaming services, based on the registration accept message. Further, the method includes performing, by the UE, one of resetting a PLMN-specific attempt counter for the PLMN, when the registration is not for disaster roaming services, or resetting the PLMN-specific attempt counter of the PLMN for a PLMN determined by the UE with a disaster condition when the registration is for disaster roaming services.

In accordance with another aspect of the disclosure, a UE for handling PLMN-specific attempt counters in a disaster roaming registration procedure in a wireless communication system is provided. The UE includes at least one processor, memory communicatively coupled to the at least one processor, and a PLMN counter handling controller communicatively coupled to the at least one processor and the memory. The PLMN counter handling controller is configured to receive registration accept message from a PLMN, based on initiation of the disaster roaming registration procedure between the UE and the PLMN. Further, the PLMN counter handling controller is configured to determine whether the registration accept message is for disaster roaming services, based on the registration accept message. Further, the PLMN counter handling controller is configured to at least one of reset a PLMN-specific attempt counter for the PLMN, when the registration is not for disaster roaming services, or reset the PLMN-specific attempt counter of the PLMN for a PLMN determined by the UE with a disaster condition when the registration is for disaster roaming services.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a sequence diagram that illustrates a process where a user equipment (UE) shall reset a public land mobile network (PLMN)-specific attempt counter for that PLMN for the specific access type for which the message was received according to the related art;

FIG. 2 is a schematic diagram that illustrates a schematic of a UE apparatus implemented to carry out the disclosed subject matter according to an embodiment of the disclosure;

FIG. 3 is a sequence diagram that illustrates a process where the UE shall reset the PLMN-specific attempt counters for the UE-determined PLMN having a disaster condition and not reset PLMN-specific attempt counters according to an embodiment of the disclosure;

FIG. 4 is a sequence diagram that illustrates a process where the UE shall reset the PLMN-specific attempt counters and not reset PLMN-specific attempt counters for the UE-determined PLMN having the disaster condition according to an embodiment of the disclosure;

FIG. 5 is a flow diagram that illustrates a method for handling PLMN-specific attempt counters in a disaster roaming registration procedure upon receiving a registration accept message from the PLMN according to an embodiment of the disclosure;

FIG. 6 is a flow diagram that illustrates a method for handling PLMN-specific attempt counters in a disaster roaming registration procedure upon receiving an attach accept message from the PLMN according to an embodiment of the disclosure; and

FIG. 7 is a flow diagram that illustrates a method for handling PLMN-specific attempt counters in a disaster roaming registration procedure upon receiving a tracking area update accept message from the PLMN according to an embodiment of the disclosure.

The same reference numerals are used to represent the same elements throughout the drawings.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The drawings help explain the technical features, but the embodiments are not limited to them. The proposed method includes any modifications, equivalents, and substitutes beyond those shown. Terms like first, second, etc., are used to distinguish elements and do not limit them.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

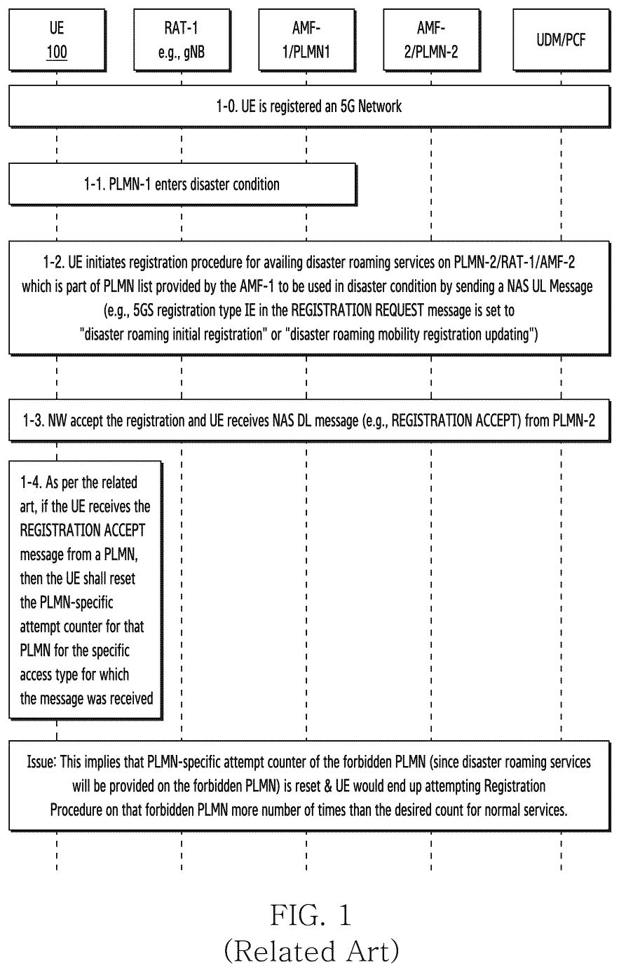

FIG. 1 is a sequence diagram that illustrates a process where a user equipment (UE) (100) shall reset a public land mobile network (PLMN)-specific attempt counter for that PLMN for the specific access type for which the message was received according to the related art.

Referring to FIG. 1, in the described problem scenario, a specific pre-condition is established as follows:
1. PLMN-specific attempt counter for PLMN-2(FPLMN) is 4.
2. The UE (100) is registered on PLMN-1/RAT-1/Access and Mobility Management Function (AMF)-1.
3. PLMN-1 enters disaster condition.
4. The UE (100) initiates registration procedure for availing disaster roaming services on PLMN-2/RAT-1/AMF-2 which is part of PLMN list provided by the AMF-1 to be used in disaster condition by sending a Non-Access Stratum (NAS) uplink (UL) Message (e.g., 5G system (5GS) registration type Information Element (IE) in the REGISTRATION REQUEST message is set to “disaster roaming initial registration” or “disaster roaming mobility registration updating”)
5. Network (NW) accepts the registration and the UE (100) receives NAS downlink (DL) message (e.g., REGISTRATION ACCEPT) from PLMN-2/AMF-2.

In the related art, when the UE (100) receives a REGISTRATION ACCEPT message from a Public Land Mobile Network (PLMN), the UE (100) resets the PLMN-specific attempt counter for that PLMN for the specific access type for which the message was received. This process results in the PLMN-specific attempt counter of a forbidden PLMN, such as PLMN-2, being reset. Consequently, the UE (100) may attempt the Registration Procedure on the forbidden PLMN more number of times than the desired count for normal services, particularly since disaster roaming services are provided on the forbidden PLMN (e.g., for the case of PLMN-specific attempt counter for PLMN-2 (FPLMN) is 4 when the Registration procedure is initiated for disaster roaming services, this counter will be reset on receiving REGISTRATION ACCEPT and hence resulting in trying the registration procedure on that FPLMN 5 more times later on. Whereas, ideally it should have been tried only one more time.

Initially, at operation 1-0, the UE (100) is registered on PLMN-1/RAT-1/AMF-1. Further, at operation 1-1, PLMN-1 enters a disaster condition. In response, at operation 1-2, the UE (100) initiates a registration procedure to avail disaster roaming services on PLMN-2/RAT-1/AMF-2. This PLMN is part of the list provided by AMF-1 for use in disaster conditions. The UE (100) sends a NAS UL Message, where the 5GS registration type Information Element (IE) in the REGISTRATION REQUEST message is set to “disaster roaming initial registration” or “disaster roaming mobility registration updating.” At operation 1-3, the network accepts the registration, and the UE (100) receives a NAS DL message, such as REGISTRATION ACCEPT, from PLMN-2.

According to the related art, at operation 1-4, if the UE (100) receives the REGISTRATION ACCEPT message from a PLMN, it resets the PLMN-specific attempt counter for that PLMN for the specific access type for which the message was received. The problem arises because this action implies that the PLMN-specific attempt counter of the forbidden PLMN (since disaster roaming services will be provided on the forbidden PLMN) is reset, leading the UE (100) to attempt the Registration Procedure on that forbidden PLMN more times than the desired count for normal services.

The proposed solution provides method and UE (100) for handling PLMN-Specific attempt counters in the disaster roaming registration procedure. The disclosure emphasizes the management of PLMN-specific attempt counters during registration for disaster roaming services in 5G networks. Depending on whether the PLMN is identified as being in a disaster condition, the UE (100) may choose to reset or retain the PLMN-specific attempt counters. In cases where the UE (100) is registering for non-disaster roaming services, the decision to reset the counters follows a similar conditional approach based on the PLMN's status. The disclosure ensures that counters related to disaster roaming services are preserved, avoiding unnecessary attempts on forbidden PLMNs and maintaining network efficiency during disaster situations. This method enhances the handling of network resources during crisis scenarios, ensuring reliable communication for the UE (100).

In one embodiment, when the UE (100) initiates a registration procedure to avail disaster roaming services on PLMN-2/RAT-1/AMF-2, which is part of the Public Land Mobile Network (PLMN) list provided by AMF-1 for use in disaster conditions, the process begins by sending a NAS UL Message. For instance, the 5G UE (5GS) registration type Information Element (IE) in the REGISTRATION REQUEST message is set to “disaster roaming initial registration” or “disaster roaming mobility registration updating.” Upon receiving this request, the Network (NW) accepts the registration by sending a NAS DL Message, such as a REGISTRATION ACCEPT message. Optionally, if the UE (100) is able to determine the PLMN associated with the disaster condition, it shall reset the PLMN-specific attempt counters for the UE-determined PLMN with the disaster condition. However, the UE (100) should not reset the PLMN-specific attempt counters in other scenarios.

In an embodiment, when the UE (100) is not able to determine the UE (100)/MS determined PLMN with a disaster condition, then upon reception of the REGISTRATION ACCEPT message, the UE (100) shall reset the PLMN-specific attempt counters. However, the UE (100) should not reset the PLMN-specific attempt counters for the UE determined PLMN with a disaster condition.

In an embodiment, when the UE (100) is unable to determine the UE/Mobile Station (MS) determined PLMN with a disaster condition, then upon receiving a REGISTRATION ACCEPT message, the UE (100) shall not reset the PLMN-specific attempt counters. However, the UE (100) should reset the PLMN-specific attempt counters for the UE determined PLMN with a disaster condition.

In an embodiment, the UE (100) resets the PLMN-specific attempt counters for the UE-determined PLMN with a disaster condition. Further, the UE (100) shall not reset the PLMN-specific attempt counters for other conditions.

In an embodiment, the UE (100) resets the PLMN-specific attempt counters. However, the UE (100) shall not reset the PLMN-specific attempt counters for the UE-determined PLMN that is associated with a disaster condition.

Disaster Roaming: This is the special roaming policy that applies during a Disaster Condition.

Disaster Condition: This is the condition that a government decides when to initiate and terminate, e.g., a natural disaster. When this condition applies, users may have the opportunity to mitigate service interruptions and failures.

Disaster Inbound Roamer: A user that (a) cannot get service from the PLMN it would normally be served by due to failure of service during a Disaster Condition and (b) is able to register with other PLMNs.

Minimization of service interruption (MINT): It is a feature that aims to enable the UE (100) to obtain service from a PLMN offering disaster roaming services when a disaster condition applies to the UE determined PLMN with disaster condition.

Registered for disaster roaming services: The UE (100) is considered as “registered for disaster roaming services” when it has successfully completed initial registration or mobility registration for disaster roaming services.

Initial registration for disaster roaming services: A registration performed with 5GS registration type “disaster roaming initial registration” in the REGISTRATION REQUEST message.

Mobility registration for disaster roaming services: A registration performed with 5GS registration type “disaster roaming mobility registration updating” in the REGISTRATION REQUEST message.

Access Technology: The access technology associated with a PLMN or Standalone Non-Public Network (SNPN). The MS uses this information to determine what type(s) of radio carrier to search for when attempting to select a specific PLMN or SNPN. The following access technologies are defined: global system for mobile communication (GSM), universal terrestrial radio access network (UTRAN), GSM COMPACT, EC-GSM-IoT, cdma2000 1×RTT, cdma2000 HRPD, evolved-universal terrestrial radio access network (E-UTRAN) (WB-S1 mode and NB-S1 mode), Next Generation Radio Access Network (NG-RAN), satellite NG-RAN, and satellite E-UTRAN (WB-S1 mode and NB-S1 mode). A PLMN may support more than one access technology. SNPNs only support NG-RAN.

MS determined PLMN with disaster condition: A PLMN to which a disaster condition applies, determined as described in clause 4.4.3.1.1.

Registered PLMN (RPLMN): This is the PLMN on which certain LR outcomes have occurred (see table 1). In a shared network, the RPLMN is the PLMN defined by the PLMN identity of the Core Network (CN) operator that has accepted the LR.

Restricted local operator services: Communication services provided by an operator that involve either automated or human assistance (e.g., credit card billing, directory assistance, customer care) for which successful authentication is not necessary.

The technology described involves various generations and types of wireless communication UEs, collectively referred to as “Rat-Type” or “Radio Access Technology (RAT)” or access technology (AT). These terms encompass a wide range of technologies from second generation (2G) to 5G, including enhancements like long term evolution (LTE) and New Radio (NR). Each generation represents an operation forward in terms of speed, efficiency, and connectivity. For instance, 2G introduced digital voice communication, third generation (3G) brought mobile internet, fourth generation (4G) enabled high-speed data transfer, and 5G is designed for ultra-fast, low-latency connections supporting a massive number of devices.

The cell in the Access technology is further connected to the core network. For an example, “E-UTRAN” maps to core network type “evolved packed core (EPC)” and access technology “NG-RAN” maps to core network type “5G Core Network (5GCN)”.

The TS 23.122 further specified the N1 mode and S1 mode:

In N1 mode: Indicates this clause applies only to an 5GS. For multi system case this is determined by the current serving radio access network.

In NB-N1 mode: Indicates this paragraph applies only to a system which operates in NB-N1 mode. For a multi-access system this case applies if the current serving radio access network provides access to 5G network services via evolved-universal terrestrial radio access (E-UTRA) connected to 5GCN by Narrowband Internet of Things (NB-IoT) (see 3GPP TS 36.300 [56], 3GPP TS 36.331 [42], 3GPP TS 36.306 [54]).

In WB-N1 mode: Indicates this paragraph applies only to a system which operates in WB-N1 mode. For a multi-access system this case applies if the system operates in N1 mode with E-UTRA connected to 5GCN, but not in NB-N1 mode.

In S1 mode: Indicates this clause applies only to an EPS. The S1 mode includes WB-S1 mode and NB-S1 mode. For multi system case this is determined by the current serving radio access network.

In NB-S1 mode: Indicates this paragraph applies only to a system which operates in NB-S1 mode. For a multi-access system this case applies if the current serving radio access network provides access to network services via E-UTRA by NB-IoT (see 3GPP TS 36.300 [56], 3GPP TS 36.331 [22], 3GPP TS 36.306 [54]).

In WB-S1 mode: Indicates this paragraph applies only to a system which operates in WB-S1 mode. For a multi-access system this case applies if the system operates in S1 mode, but not in NB-S1 mode.

In an embodiment, if the AMF determines that a disaster condition applies to the PLMN with disaster condition, and the UE (100) is allowed to be registered for disaster roaming services (when AMF receive the registration request with registration type information element (IE) in the REGISTRATION REQUEST message is set to “disaster roaming initial registration” or “disaster roaming mobility registration updating.”), the AMF shall set the Disaster roaming registration result value bit in the 5GS registration result IE to “no additional information” in the REGISTRATION ACCEPT message to indicate that the registration is accepted as disaster roaming services. If the AMF determines that the UE (100) can be registered to the PLMN for normal service, the AMF shall set the Disaster roaming registration result value bit in the 5GS registration result IE to “request for registration for disaster roaming service accepted as registration not for disaster roaming service” in the REGISTRATION ACCEPT message.

In an embodiment, attached for disaster roaming services: The UE (100) is considered as “attached for disaster roaming services in EPS” when it has successfully completed attach or tracking area update for disaster roaming services. The UE (100) attaching for the disaster roaming service set the EPS attach type IE in the ATTACH REQUEST message to “disaster roaming attach” or set the EPS update type IE in TRACKING AREA UPDATE REQUEST message to disaster roaming update The MME (Mobility management entity) sends the ATTACH ACCEPT (attach accept message is for the disaster roaming services), TRACKING AREA UPDATE ACCEPT (tracking area update accept message is for the disaster roaming service)

In an embodiment, the UE (100) maintains a PLMN-specific attempt counters (as specified in 3GPP TS 24.301 [15]). The maximum number of possible entries in the list is implementation dependent. This list is applicable to access attempts via 3GPP access only, a list of PLMN-specific attempt counters for the UE determined PLMN with disaster condition, if the UE (100) supports MINT. The maximum number of possible entries in the list is implementation dependent. This list is applicable to access attempts via 3GPP access only

When the UE (100) receives EPS Mobility Management (EMM) or 5G Mobility Management (5GMM) cause value (not in HPLMN and Equivalent Home PLMN (EHPLMN)) received is e.g., #11, #36 or #73 and if the message was received via 3GPP access and if the PLMN-specific attempt counter for the PLMN sending the reject message has a value less than a UE implementation-specific maximum value, the UE (100) shall increment the PLMN-specific attempt counter for the PLMN.

If the 5GMM or EMM cause value received is e.g., #80, then If the PLMN-specific attempt counter of the PLMN which sent the reject message for the UE (100) determined PLMN with disaster condition has a value less than a UE implementation-specific maximum value, the UE (100) shall increment the PLMN-specific attempt counter of the PLMN which sent the reject message for the UE (100) determined PLMN with disaster condition.

In an embodiment, in PLMN selection procedure as specified in TS 23.122 (e.g., Automatic Network Selection Mode Procedure) the UE (100) determines PLMN with disaster condition as follows:

Broadcasting the “list of one or more PLMN(s) with disaster condition for which disaster roaming services is offered by the available PLMN”, the MS shall determine the UE (100) determined PLMN with disaster condition as follows:
i) if the MS's RPLMN is included in any “list of one or more PLMN(s) with disaster condition for which disaster roaming services is offered by the available PLMN” broadcast by any NG-RAN or E-UTRAN cell and is allowable, the MS shall consider that the MS's RPLMN is the UE (100) determined PLMN with disaster condition; or
ii) if the MS's RPLMN is not included in any “list of one or more PLMN(s) with disaster condition for which disaster roaming services is offered by the available PLMN” broadcast by any NG-RAN or E-UTRAN cell or the MS's RPLMN is not allowable or the MS does not have a RPLMN (see table 1), the MS shall determine the UE (100) determined PLMN with disaster condition from PLMNs:
in the “list of one or more PLMN(s) with disaster condition for which disaster roaming services is offered by the available PLMN” broadcast by any NG-RAN or E-UTRAN cell; and
which are allowable;
in the following order:
   either the HPLMN (if the EHPLMN list is not present or is empty) or the highest priority EHPLMN that is available (if the EHPLMN list is present);
   each PLMN in the “User Controlled PLMN Selector with Access Technology” data file in the subscriber identification module (SIM) (in priority order);
   each PLMN in the “Operator Controlled PLMN Selector with Access Technology” data file in the SIM (in priority order) or stored in the ME (in priority order); and
   other PLMNs.
B) broadcasting the “disaster related indication”, the MS shall attempt to determine the UE (100) determined PLMN with disaster condition as follows:
1) if the country of the MS's RPLMN matches the country of a PLMN for which any NG-RAN or E-UTRAN cell broadcasts the “disaster related indication” and the MS's RPLMN is allowable, the MS shall consider that the MS's RPLMN is the UE determined PLMN with disaster condition; or
2) if the country of the MS's RPLMN does not match the country of any PLMN for which any NG-RAN or E-UTRAN cell broadcasts the “disaster related indication” or the MS's RPLMN is not allowable, the MS shall determine the UE determined PLMN with disaster condition from allowable PLMN(s) where the country of allowable PLMN(s) matches the country of a PLMN for which any NG-RAN or E-UTRAN cell broadcasts the “disaster related indication” in the following order:
   either the HPLMN (if the EHPLMN list is not present or is empty) or the highest priority EHPLMN that is available (if the EHPLMN list is present);
   each PLMN in the “User Controlled PLMN Selector with Access Technology” data file in the SIM (in priority order);
   each PLMN in the “Operator Controlled PLMN Selector with Access Technology” data file in the SIM (in priority order) or stored in the ME (in priority order).

Further, these technologies include specific adaptations for different environments, such as NR in unlicensed bands for flexible spectrum usage and satellite access (Low Earth Orbit (LEO), Medium Earth Orbit (MEO), Geosynchronous Orbit (GEO), and others) for global coverage, even in remote areas. Technologies like NB-IoT and Long-Term Evolution for Machines (LTE-M) are tailored for the Internet of Things (IoT), providing efficient, low-power connectivity for smart devices. This extensive suite of technologies allows for robust and versatile communication networks capable of supporting a wide range of applications, from everyday mobile communications to advanced IoT and satellite communications.

When the UE (100) initiates a registration procedure to avail disaster roaming services on PLMN-2/RAT-1/AMF-2, which is part of the PLMN list provided by AMF-1 for use in disaster conditions, it does so by sending a NAS UL Message. For instance, the 5GS registration type IE in the REGISTRATION REQUEST message is set to “disaster roaming initial registration” or “disaster roaming mobility registration updating.” Upon receiving this request, the NW (network. e.g., AMF) accepts the registration for the disaster roaming services by sending a NAS DL Message, such as a REGISTRATION ACCEPT message. Optionally, if the UE (100) is able to determine the PLMN associated with the disaster condition, it shall reset the PLMN-specific attempt counters of the PLMN (in this case PLMN-2) for the UE-determined PLMN with the disaster condition. However, the UE (100) should not reset the PLMN-specific attempt counters.

In an embodiment, when the UE (100) initiates a registration procedure on a PLMN, RAT, or AMF by sending a NAS uplink message for non-disaster-roaming services, the registration type information element (IE) in the REGISTRATION REQUEST message is not set to “disaster roaming initial registration” or “disaster roaming mobility registration updating.” Instead, it is optionally set to at least one of the following: initial registration, mobility registration updating, periodic registration updating (optionally when the UE (100) is not already registered with disaster roaming service or not attached for disaster roaming services), emergency registration, or SNPN onboarding registration. Upon acceptance of the registration by the network, indicated by the sending of a NAS downlink message such as REGISTRATION ACCEPT. In such cases, the UE (100) shall reset the PLMN-specific attempt counters for that PLMN. However, the UE (100) should not reset the PLMN-specific attempt counters of the PLMN for the UE-determined PLMN with a disaster condition.

In an embodiment, if the UE (100) is unable to determine the UE/MS determined PLMN under a disaster condition, the following actions are taken upon reception of a REGISTRATION ACCEPT message. The UE (100) shall reset the PLMN-specific attempt counters. However, the PLMN-specific attempt counters for the UE determined PLMN with a disaster condition should not be reset.

In an embodiment, if the UE (100) is unable to determine the UE/MS determined PLMN with a disaster condition, then upon receiving a REGISTRATION ACCEPT message, the UE (100) shall not reset the PLMN-specific attempt counters for that PLMN. However, the UE (100) should reset the PLMN-specific attempt counters for the UE determined PLMN with the disaster condition.

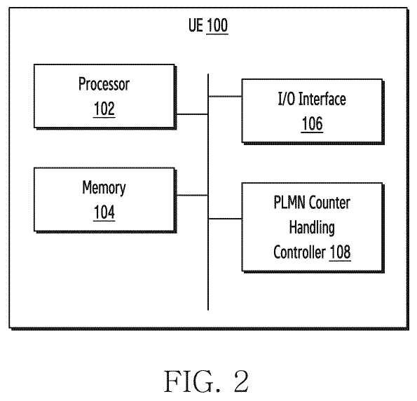

FIG. 2 is a schematic diagram that illustrates a schematic of a UE (100) apparatus implemented to carry out the disclosed subject matter according to an embodiment of the disclosure. Examples of the UE (100) can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

Referring to FIG. 2, the UE (100) includes a processor (102), memory (104), an input-output (I/O) interface (106), a PLMN counter handling controller (108) coupled to the processor (102) and the memory (104). Each component is explained in further detail below.

The processor (102) communicates with the memory (104), the I/O interface (106), and the PLMN counter handling controller (108). Configured to execute instructions stored in the memory (104) and perform various processes, the processor (102) includes one or more processors. It can be a general-purpose processor like a CPU, an application processor (AP), a graphics processing unit (GPU), a visual processing unit (VPU), or an artificial intelligence (AI)-dedicated processor such as a neural processing unit (NPU). The processor (102) is designed with advanced power management features to optimize energy consumption during high computational loads. It also supports parallel processing and hardware acceleration to enhance the efficiency of complex tasks.

The memory (104) includes the capabilities supported by the UE (100). It comprises both volatile and non-volatile memory, including various computer-readable storage media like magnetic hard disks, optical disks, floppy disks, flash memories, erasable programmable read only memory (EPROM), and electrically erasable programmable read only memory (EEPROM). The memory (104) is equipped with error-correcting codes (ECC) to ensure data integrity and reliability. It also supports high-speed data access and transfer rates to facilitate real-time processing and analytics.

Information is transmitted between the memory (104) and external peripheral devices via the I/O interface (106), which connects input-output devices associated with the UE (100). The PLMN counter handling controller (108) also communicates with the I/O interface (106) and the memory (104). This coupling allows data transfer and communication between components, enabling the PLMN counter handling controller (108) for handling PLMN-specific attempt counters in a disaster roaming registration procedure.

An innovative integrated circuit, the PLMN counter handling controller (108), is implemented in the UE (100). In an embodiment, the structure of such an innovative integrated circuit includes a multi-core architecture that enables handling PLMN-specific attempt counters in a disaster roaming registration procedure. Each core is optimized for specific tasks such as resetting PLMN-specific attempt counter for the PLMN. The innovative integrated circuit for the above-mentioned points is made of a combination of analog and digital components designed to enable handling PLMN-specific attempt counters in a disaster roaming registration procedure. Analog components include a low-noise amplifier and a high-precision analog-to-digital converter to ensure signal processing. Digital components consist of a microcontroller unit (MCU) and a digital signal processor (DSP) that work in tandem to enable handling PLMN-specific attempt counters in a disaster roaming registration procedure.

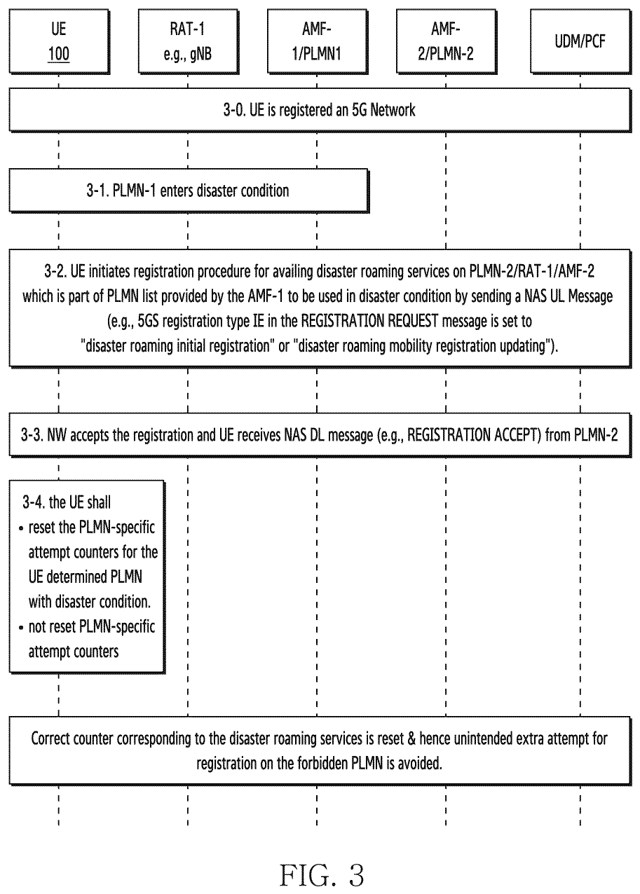

FIG. 3 is a sequence diagram that illustrates a process where the UE (100) shall reset the PLMN-specific attempt counters for the UE-determined PLMN with disaster condition and not reset PLMN-specific attempt counters according to an embodiment of the disclosure.

Let's consider the PLMN-specific attempt counters for the PLMN-2 stored in the UE (100) are:
PLMN specific counter=x
PLMN specific counter for the UE determined PLMN with disaster condition (PLMN-1)=y

At operation 3-0, the UE (100) is registered on PLMN-1/RAT-1/AMF-1. Further, at operation 3-1, PLMN-1 enters a disaster condition. In response, at operation 3-2, the UE (100) initiates a registration procedure to avail disaster roaming services on PLMN-2/RAT-1/AMF-2. This PLMN is part of a list provided by AMF-1 for use during disaster conditions. The UE (100) sends a NAS UL Message, where the 5GS registration type IE in the REGISTRATION REQUEST message is set to “disaster roaming initial registration” or “disaster roaming mobility registration updating.”

At operation 3-3, the NW accepts the registration, and the UE (100) receives a NAS DL message, such as a REGISTRATION ACCEPT (indicating the registration accepted as disaster roaming services), from PLMN-2. Furthermore, at operation 3-4, the UE (100) performs specific actions regarding the PLMN-specific attempt counters. The UE (100) resets the PLMN-specific attempt counters for the PLMN determined to be in a disaster condition (i.e., y is set to zero). However, the UE (100) does not reset the PLMN-specific attempt counters for other conditions, as per the embodiments disclosed herein.

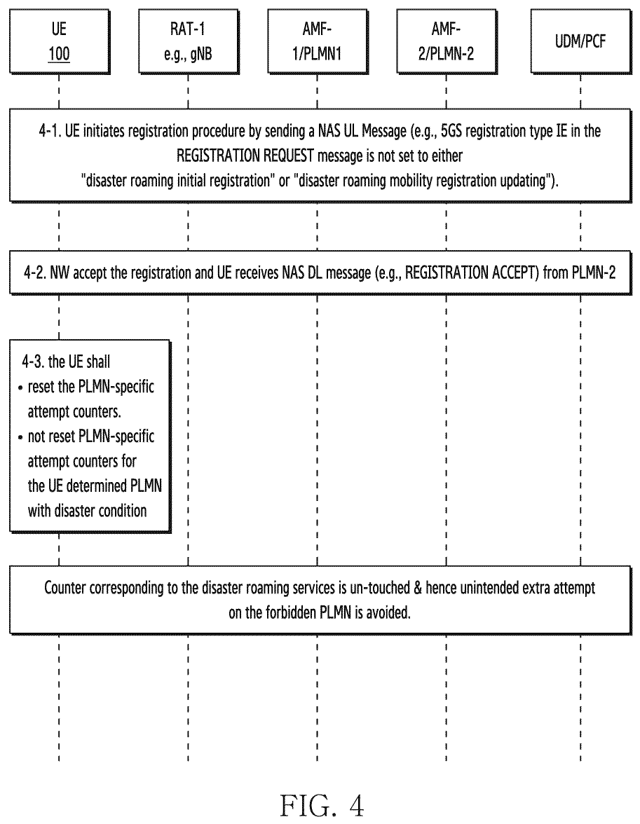

FIG. 4 is a sequence diagram that illustrates a process where the UE (100) shall reset the PLMN-specific attempt counters and not reset PLMN-specific attempt counters for the UE-determined PLMN with disaster condition according to an embodiment of the disclosure.

Let's consider the PLMN-specific attempt counters for the PLMN-2 stored in the UE (100) are:
PLMN specific counter=x
PLMN specific counter for the UE determined PLMN with disaster condition (PLMN-1)=y

At operation 4-1, the UE (100) initiates a registration procedure by sending a NAS Uplink (UL) Message. Notably, the 5G system (5GS) registration type Information Element (IE) in the REGISTRATION REQUEST message is not set to either “disaster roaming initial registration” or “disaster roaming mobility registration updating.”

Further, at operation 4-2, the network (NW) accepts the registration, and the UE (100) receives a NAS Downlink (DL) message, such as a REGISTRATION ACCEPT, from PLMN-2. At operation 4-3, the UE (100) performs the following actions: it resets the PLMN-specific attempt counters (i.e., x is set to zero), but does not reset the counters for the UE-determined PLMN with disaster conditions (UE doesn't reset y).

In an embodiment, the counter corresponding to disaster roaming services remains untouched, thereby avoiding unintended extra attempts on the forbidden PLMN.

In an embodiment, the Registration Type IE mentioned in the proposed solution corresponds to any of the types specified in the 3GPP TS 24.501 standard.

TABLE 1
5GS registration type value (octet 1, bits 1 to 3)
Bits

| | | | |
|---|---|---|---|
| 3 | 2 | 1 | |
| 0 | 0 | 1 | initial registration |
| 0 | 1 | 0 | mobility registration updating |
| 0 | 1 | 1 | periodic registration updating |
| 1 | 0 | 0 | emergency registration |
| 1 | 0 | 1 | SNPN onboarding registration |
| 1 | 1 | 0 | disaster roaming mobility registration |
| | | | updating |
| 1 | 1 | 1 | disaster roaming initial registration |

All other values are unused and shall be interpreted as “initial registration”, if received by the network.

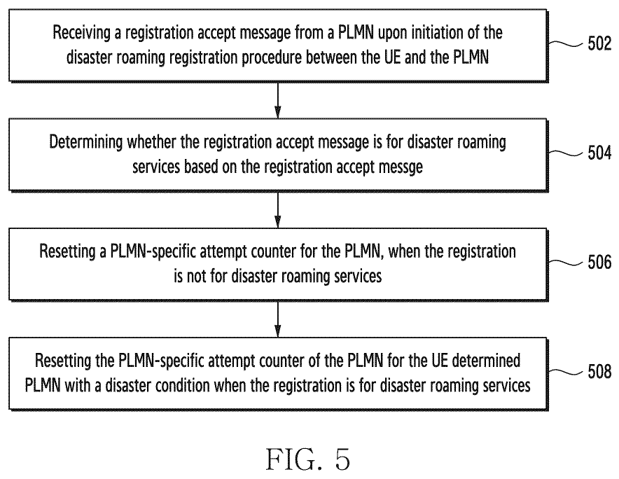

FIG. 5 is a flow diagram that illustrates a method for handling PLMN-specific attempt counters in a disaster roaming registration procedure upon receiving a registration accept message from the PLMN according to an embodiment of the disclosure. The method includes operations 502 to 508. Each operation is explained in further detail below.

At operation 502, the method includes receiving by the UE (100) a registration accept message from a PLMN upon initiation of the disaster roaming registration procedure between the UE (100) and the PLMN. At operation 504, the method includes determining by the UE (100) whether the registration accept message is for disaster roaming services based on the registration accept message.

At operation 506, the method includes resetting by the UE (100) a PLMN-specific attempt counter for the PLMN, when the registration is not for disaster roaming services. At operation 508, the method includes resetting by the UE (100) the PLMN-specific attempt counter of the PLMN for a PLMN determined by the UE (100) with a disaster condition when the registration is for disaster roaming services.

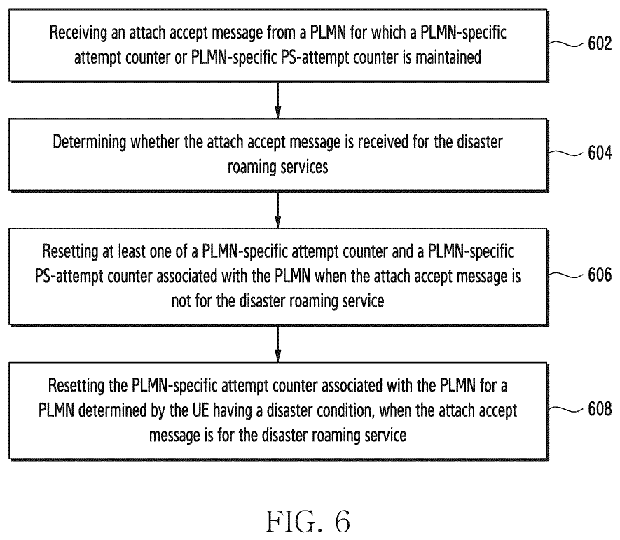

FIG. 6 is a flow diagram that illustrates a method for handling PLMN-specific attempt counters in a disaster roaming attach procedure in EPS upon receiving an attach accept message from the PLMN according to an embodiment of the disclosure. The method includes operation 602 to 608. Each operation is explained in further detail below.

At operation 602, the method includes receiving by the UE (100) an attach accept message from a PLMN for which a PLMN-specific attempt counter or PLMN-specific packet switched (PS)-attempt counter is maintained. At operation 604, the method includes determining by the UE (100) whether the attach accept message is received for the disaster roaming services.

At operation 606, the method includes resetting by the UE (100) at least one of a PLMN-specific attempt counter or a PLMN-specific PS-attempt counter associated with the PLMN when the attach accept message is not for the disaster roaming service. At operation 608, the method includes resetting by the UE (100) the PLMN-specific attempt counter associated with the PLMN for a PLMN determined by the UE (100) as having a disaster condition, when the attach accept message is for the disaster roaming service.

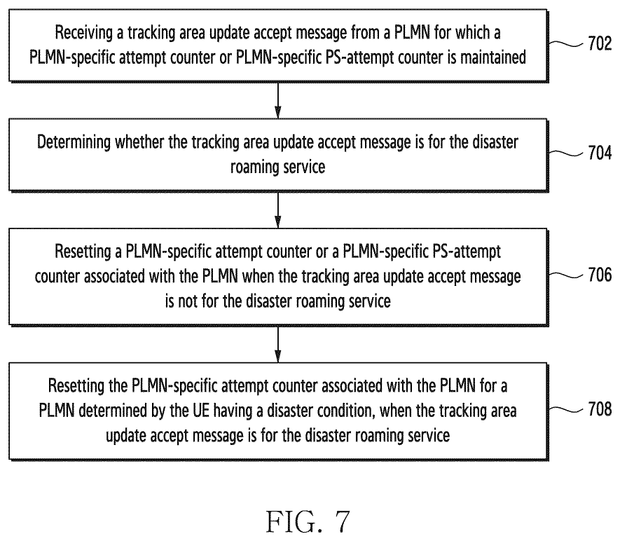

FIG. 7 is a flow diagram that illustrates a method for handling PLMN-specific attempt counters in a disaster roaming tracking area update procedure upon receiving a tracking area update accept message from the PLMN according to an embodiment of the disclosure. The method includes operations 702 to 708. Each operation is explained in further detail below.

At operation 702, the method includes receiving by the UE (100) tracking area update accept message from a PLMN for which a PLMN-specific attempt counter or PLMN-specific PS-attempt counter is maintained. At operation 704, the method includes determining by the UE (100) whether the tracking area update accept message is for the disaster roaming service.

At operation 706, the method includes resetting by the UE (100) a PLMN-specific attempt counter or a PLMN-specific PS-attempt counter associated with the PLMN when the tracking area update accept message is not for the disaster roaming service. At operation 708, the method includes resetting by the UE (100) the PLMN-specific attempt counter associated with the PLMN for a PLMN determined by the UE (100) as having a disaster condition, when the tracking area update accept message is for the disaster roaming service.

In an embodiment, a method performed by a user equipment (UE) may comprise transmitting, to a mobility management node (e.g., an access and mobility management function (AMF) or a mobility management entity (MME)), a request message for a public land mobile network (PLMN). The method may comprise receiving, from the mobility management node, an accept message in response to the request message. The method may comprise, in a case that the request message is for disaster roaming services, resetting a first PLMN-specific attempt counter of the PLMN related to a disaster condition. The method may comprise in a case that the request message is not for the disaster roaming services, resetting a second PLMN-specific attempt counter different from the first PLMN-specific attempt counter.

In an embodiment, the request message and the accept message may be for an initial registration for the disaster roaming services. The request message may be a registration request message. The accept message may be a registration accept message. The request message may include a 5th generation system (5GS) registration type indicating a disaster roaming initial registration.

In an embodiment, the request message and the accept message may be for a mobility registration for the disaster roaming services. The request message may be a registration request message. The accept message may be a registration accept message. The request message may include a 5GS registration type indicating a disaster roaming mobility registration updating.

In an embodiment, the request message may be an attach request message. The accept message may be an attach accept message. The request message may include an evolved packet system (EPS) attach type indicating a disaster roaming attach in an EPS.

In an embodiment, the request message may be a tracking area update request message. The accept message may be a tracking area update accept message. The request message may include an EPS attach type indicating a disaster roaming tracking area updating in an EPS.

In an embodiment, the method may comprise, before transmitting the request message, receiving a list of one or more PLMNs with the disaster condition. The method may comprise determining the PLMN as a UE determined PLMN with the disaster condition based on the list one or more PLMNs.

In an embodiment, the disaster condition may be a condition that a government decides when to initiate and terminate.

In an embodiment, a user equipment (UE) may comprise at least one processor. The UE may comprise memory storing instructions. The instructions, when executed by the at least one processor, may cause the UE to transmit, to a mobility management node, a request message for a public land mobile network (PLMN). The instructions, when executed by the at least one processor, may cause the UE to receive, from the mobility management node, an accept message in response to the request message. The instructions, when executed by the at least one processor, may cause the UE to, in a case that the request message is for disaster roaming services, reset a first PLMN-specific attempt counter of the PLMN related to a disaster condition. The instructions, when executed by the at least one processor, may cause the UE to, in a case that the request message is not for the disaster roaming services, reset a second PLMN-specific attempt counter different from the first PLMN-specific attempt counter.

In an embodiment, the request message and the accept message may be for an initial registration for the disaster roaming services. The request message may be a registration request message. The accept message may be a registration accept message. The request message may include a 5th generation system (5GS) registration type indicating a disaster roaming initial registration.

In an embodiment, In an embodiment, the request message and the accept message may be for a mobility registration for the disaster roaming services. The request message may be a registration request message. The accept message may be a registration accept message. The request message may include a 5GS registration type indicating a disaster roaming mobility registration updating.

In an embodiment, the request message may be an attach request message. The accept message may be an attach accept message. The request message may include an evolved packet system (EPS) attach type indicating a disaster roaming attach in an EPS.

In an embodiment, the request message may be a tracking area update request message. The accept message may be a tracking area update accept message. The request message may include an EPS attach type indicating a disaster roaming tracking area updating in an EPS.

In an embodiment, the instructions, when executed by the at least one processor, may cause the UE to, before transmitting the request message, receive a list of one or more PLMNs with the disaster condition. The instructions, when executed by the at least one processor, may cause the UE to determine the PLMN as a UE determined PLMN with the disaster condition based on the list one or more PLMNs.

In an embodiment, the disaster condition may be a condition that a government decides when to initiate and terminate.

In an embodiment, a non-transitory computer readable storage medium may store one or more programs. The one or more programs may comprise instructions. The instructions, when executed by at least one processor of a user equipment (UE), may cause the UE to transmit, to a mobility management node, a request message for a public land mobile network (PLMN). The instructions, when executed by at least one processor of the UE, may cause the UE to receive, from the mobility management node, an accept message in response to the request message. The instructions, when executed by at least one processor of the UE, may cause the UE to, in a case that the request message is for disaster roaming services, reset a first PLMN-specific attempt counter of the PLMN related to a disaster condition. The instructions, when executed by at least one processor of the UE, may cause the UE to, in a case that the request message is not for the disaster roaming services, reset a second PLMN-specific attempt counter different from the first PLMN-specific attempt counter.

In an embodiment, the request message and the accept message may be for an initial registration for the disaster roaming services. The request message may be a registration request message. The accept message may be a registration accept message. The request message may include a 5th generation system (5GS) registration type indicating a disaster roaming initial registration.

In an embodiment, the request message and the accept message may be for a mobility registration for the disaster roaming services. The request message may be a registration request message. The accept message may be a registration accept message. The request message may include a 5GS registration type indicating a disaster roaming mobility registration updating.

In an embodiment, the request message may be an attach request message. The accept message may be an attach accept message. The request message may include an evolved packet system (EPS) attach type indicating a disaster roaming attach in an EPS.

In an embodiment, the request message may be a tracking area update request message. The accept message may be a tracking area update accept message. The request message may include an EPS attach type indicating a disaster roaming tracking area updating in an EPS.

In an embodiment, the instructions, when executed by the at least one processor, may cause the UE to, before transmitting the request message, receive a list of one or more PLMNs with the disaster condition. The instructions, when executed by the at least one processor, may cause the UE to determine the PLMN as a UE determined PLMN with the disaster condition based on the list one or more PLMNs. The disaster condition may be a condition that a government decides when to initiate and terminate.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE), the method comprising:
transmitting, to a mobility management node, a request message for a public land mobile network (PLMN);
receiving, from the mobility management node, an accept message in response to the request message;
in a case that the request message is for disaster roaming services, resetting a first PLMN-specific attempt counter of the PLMN related to a disaster condition; and
in a case that the request message is not for the disaster roaming services, reset ting a second PLMN-specific attempt counter different from the first PLMN-specific a ttempt counter.

2. The method of claim 1,
wherein the request message and the accept message are for an initial registration for the disaster roaming services,
wherein the request message is a registration request message,
wherein the accept message is a registration accept message, and
wherein the request message includes a 5th generation system (5GS) registration type indicating a disaster roaming initial registration.

3. The method of claim 1,
wherein the request message and the accept message are for a mobility registration for the disaster roaming services,
wherein the request message is a registration request message,
wherein the accept message is a registration accept message, and
wherein the request message includes a 5th generation system (5GS) registration type indicating a disaster roaming mobility registration updating.

4. The method of claim 1,
wherein the request message is an attach request message,
wherein the accept message is an attach accept message, and
wherein the request message includes an evolved packet system (EPS) attach type indicating a disaster roaming attach in an EPS.

5. The method of claim 1,
wherein the request message is a tracking area update request message,
wherein the accept message is a tracking area update accept message, and
wherein the request message includes an evolved packet system (EPS) attach type indicating a disaster roaming tracking area updating in an EPS.

6. The method of claim 1, further comprising:
before transmitting the request message, receiving a list of one or more PLMNs with the disaster condition; and
determining the PLMN as a UE determined PLMN with the disaster condition based on the list of one or more PLMNs.

7. The method of claim 1,
wherein the disaster condition is a condition that a government decides when to initiate and terminate.

8. A user equipment (UE) comprising:
at least one processor; and
memory, storing instructions, wherein the instructions, when executed by the at least one processor, cause the UE to:
transmit, to a mobility management node, a request message for a public land mobile network (PLMN);
receive, from the mobility management node, an accept message in response to the request message;
in a case that the request message is for disaster roaming services, reset a first PLMN-specific attempt counter of the PLMN related to a disaster condition; and
in a case that the request message is not for the disaster roaming services, reset a second PLMN-specific attempt counter different from the first PLMN-specific attem pt counter.

9. The UE of claim 8,
wherein the request message and the accept message are for an initial registration for the disaster roaming services,
wherein the request message is a registration request message,
wherein the accept message is a registration accept message, and
wherein the request message includes a 5th generation system (5GS) registration type indicating a disaster roaming initial registration.

10. The UE of claim 8,
wherein the request message and the accept message are for a mobility registration for the disaster roaming services,
wherein the request message is a registration request message,
wherein the accept message is a registration accept message, and
wherein the request message includes a 5th generation system (5GS) registration type indicating a disaster roaming mobility registration updating.

11. The UE of claim 8,
wherein the request message is an attach request message,
wherein the accept message is an attach accept message, and
wherein the request message includes an evolved packet system (EPS) attach type indicating a disaster roaming attach in an EPS.

12. The UE of claim 8,
wherein the request message is a tracking area update request message,
wherein the accept message is a tracking area update accept message, and
wherein the request message includes an evolved packet system (EPS) attach type indicating a disaster roaming tracking area updating in an EPS.

13. The UE of claim 8, wherein the instructions, when executed by the at least one processor, cause the UE to:
before transmitting the request message, receive a list of one or more PLMNs with the disaster condition; and
determine the PLMN as a UE determined PLMN with the disaster condition based on the list of one or more PLMNs.

14. The UE of claim 8,
wherein the disaster condition is a condition that a government decides when to initiate and terminate.

15. A non-transitory computer readable storage medium storing one or more programs, wherein the one or more programs comprise instructions, wherein the instructions, when executed by at least one processor of a user equipment (UE), cause the UE to:
transmit, to a mobility management node, a request message for a public land mobile network (PLMN);
receive, from the mobility management node, an accept message in response to the request message;
in a case that the request message is for disaster roaming services, reset a first PLMN-specific attempt counter of the PLMN related to a disaster condition; and
in a case that the request message is not for the disaster roaming services, reset a second PLMN-specific attempt counter different from the first PLMN-specific attem pt counter.

16. The non-transitory computer readable storage medium of claim 15,
wherein the request message and the accept message are for an initial registration for the disaster roaming services,
wherein the request message is a registration request message,
wherein the accept message is a registration accept message, and
wherein the request message includes a 5th generation system (5GS) registration type indicating a disaster roaming initial registration.

17. The non-transitory computer readable storage medium of claim 15,
wherein the request message and the accept message are for a mobility registration for the disaster roaming services,
wherein the request message is a registration request message,
wherein the accept message is a registration accept message, and
wherein the request message includes a 5th generation system (5GS) registration type indicating a disaster roaming mobility registration updating.

18. The non-transitory computer readable storage medium of claim 15,
wherein the request message is an attach request message,
wherein the accept message is an attach accept message, and
wherein the request message includes an evolved packet system (EPS) attach type indicating a disaster roaming attach in an EPS.

19. The non-transitory computer readable storage medium of claim 15,
wherein the request message is a tracking area update request message,
wherein the accept message is a tracking area update accept message, and
wherein the request message includes an evolved packet system (EPS) attach type indicating a disaster roaming tracking area updating in an EPS.

20. The non-transitory computer readable storage medium of claim 15,
wherein the instructions, when executed by at least one processor, cause the UE to:
before transmitting the request message, receive a list of one or more PLMNs with the disaster condition; and
determine the PLMN as a UE determined PLMN with the disaster condition based on the list of one or more PLMNs, and
wherein the disaster condition is a condition that a government decides when to initiate and terminate.
